(19) United States
(12) Patent Application Publication
(10) Pub. No.: US 2017/0153721 A1
(43) Pub. Date: Jun. 1, 2017

(54) ACTIVE STYLUS

(71) Applicant: EMRight Technology Co., Ltd., Hsinchu City (TW)

(72) Inventors: Chia-Te HUANG, New Taipei City (TW); Yan-Chin HSU, Hsinchu County (TW)

(21) Appl. No.: 15/151,917

(22) Filed: May 11, 2016

(30) Foreign Application Priority Data
Nov. 27, 2015 (TW) 104219143

(51) Int. Cl. G06F 3/0354; G06F 3/044

(52) U.S. Cl. CPC G06F 3/03545; G06F 3/044

(57) ABSTRACT

An active stylus, applied to a capacitive touch panel as an input means can include a housing, an induction-coil portion, a penetration portion and a magnetic structure. The induction-coil portion is located inside the housing. The penetration portion located at an end portion of the housing and movably mounted at the induction-coil portion further includes a contact portion protrusive out of the housing to contact the capacitive touch panel. When the contact portion contacts the capacitive touch panel, the contact portion moves the penetration portion and the magnetic structure synchronously so as to generate a relative displacement between the magnetic structure and the induction-coil portion and further to have the induction-coil portion to produce a change of inductance.

This application claims the benefit of Taiwan Patent Application Serial No. 104219143, filed Nov. 27, 2015, the subject matter of which is incorporated herein by reference.

### BACKGROUND OF INVENTION

1. Field of the Invention

The invention relates to a stylus, and more particularly to an active stylus that can be applied a touch panel.

2. Description of the Prior Art

Among all the consumer electronics in the market place, products with touch panels become popular. Particularly, in the art of touch panels, a capacitive touch panel is featured in utilizing human conductivity and static electricity. When user's finger touches directly a touch area of the touch panel, the capacitance at the contact point would be changed. Thus, the touch panel can judge the exact position of the contact point according to the change of the capacitance.

Though the aforesaid finger operation could be so straight forward and convenient, yet such an operation could not be so relevant to all situations. For example of hand writing, mass or swift input might be significantly retarded by the friction between the finger and the touch panel. Also, while in clicking an application, mis-selection might occur due to the not-so-small touch area produced by the finger.

To resolve the aforesaid shortcomings, a stylus is developed. Currently, the stylus can be passive or active. The passive active stylus applies a conductive pen tip as a medium between the touch panel and the user. When a user manipulates the active stylus to touch the touch panel, the capacitance at the touch point of stylus's pen tip would vary, and thereby the exact coordinate of the touch point on the touch panel can be precisely located by judging the change of capacitance over the touch panel. However, the judgment of the touch point could still be weak if the touch area provided by the passive stylus upon the touch screen is too small. Such a limitation for the pen tip of the stylus would influence the design of the stylus, especially at the pen tip. If the touch area provided by the pen tip on the touch screen is too small, then the judgment thereof might be weak. However, if the touch area provided by the pen tip on the touch screen is too big, then a precise pin-point judgment at the contact point might be difficult. On the other hand, the active stylus includes at least a power-managing unit, a control unit, a contact-detecting element and a signal-generating circuit. When the active stylus touch the touch panel, the contact-detecting element would be activated, and the control unit would realize the data provided by the contact-detecting element so as to obtain information regarding the instant touching of the pen tip of the active stylus on the touch careen. To precisely calculate the touching, a precision control unit is definitely required. However, such a control unit in the art is usually expensive and has a non-negligible size. To implement the precision control unit into the active stylus, complicate structuring, bigger sizing and higher pricing would be inevitable.

### SUMMARY OF THE INVENTION

Accordingly, it is the primary object of the present invention to provide an active stylus. When a pen tip of the active stylus contacts a touch panel, a relative displacement between a magnetic structure and an induction unit would be generated. This relative displacement is further realized as a change of inductance for calculating a pressure at the pen tip of the depressed active stylus on the touch panel.

In the present invention, the active stylus, applied to a capacitive touch panel as an input means can include a housing, an induction-coil portion, a penetration portion and a magnetic structure. The induction-coil portion is located inside the housing. The penetration portion located at an end portion of the housing and movably mounted at the induction-coil portion further includes a contact portion protrusive out of the housing to contact the capacitive touch panel. When the contact portion contacts the capacitive touch panel, the contact portion moves the penetration portion and the magnetic structure synchronously so as to generate a relative displacement between the magnetic structure and the induction-coil portion and further to have the induction-coil portion to produce a change of inductance.

In the present invention, the active stylus, applied to a capacitive touch panel as an input means can include a housing, an induction-coil portion, a penetration portion, an elastic unit and a magnetic structure. The induction-coil portion is located inside the housing. The penetration portion located at an end portion of the housing and movably mounted at the induction-coil portion further includes a contact portion protrusive out of the housing to contact the capacitive touch panel. The elastic unit connects the induction-coil portion, and the magnetic structure connects the elastic unit. When the contact portion contacts the capacitive touch panel, the contact portion moves the penetration portion and the magnetic structure synchronously so as to generate a relative displacement between the magnetic structure and the induction-coil portion and further to have the induction-coil portion to produce a change of inductance.

Thus, by providing the active stylus of the present invention, when the contact portion of the penetration portion contacts the capacitive touch panel, such a contact would move the contact portion, the penetration portion and the magnetic structure synchronously so as to generate a relative displacement between the magnetic structure and the induction-coil portion, and further to have the induction-coil portion to produce a change of inductance. The oscillation unit bases on the change of inductance to generate a corresponding oscillation frequency. Thus, the capacitive touch panel can then calculate the pressure value at the contact portion of the depressed penetration portion. Hence, the active stylus of the present invention does not need the control unit, such as the MCU or the microprocessor of the conventional active stylus, to calculate the pressure value at the pen-tip of the depressed active stylus. Thus, the overall volume of the active stylus can be smaller, the production cost for the active stylus can be reduced, and the usage convenience of the active stylus can be enhanced.

All these objects are achieved by the active stylus described below.

### BRIEF DESCRIPTION OF THE DRAWINGS

The present invention will now be specified with reference to its preferred embodiment illustrated in the drawings, in which:

FIG. 1 is a schematic view of an embodiment of the active stylus in accordance with the present invention;

FIG. 2 is an enlarged view of a portion of FIG. 1;

FIG. 3 shows another state of FIG. 2;

FIG. 4 is a schematic detail view of the positioning unit of FIG. 1;

FIG. 5 is a schematic view of another embodiment of the active stylus in accordance with the present invention;

FIG. 6 is a schematic view of a further embodiment of the active stylus in accordance with the present invention; and

FIG. 7 is a schematic detail view of the penetration portion of FIG. 1.

### DESCRIPTION OF THE PREFERRED EMBODIMENT

The invention disclosed herein is directed to an active stylus. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

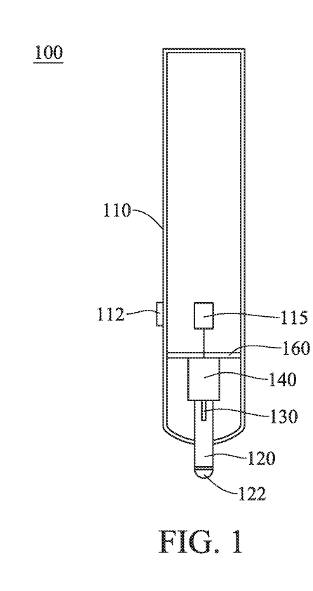

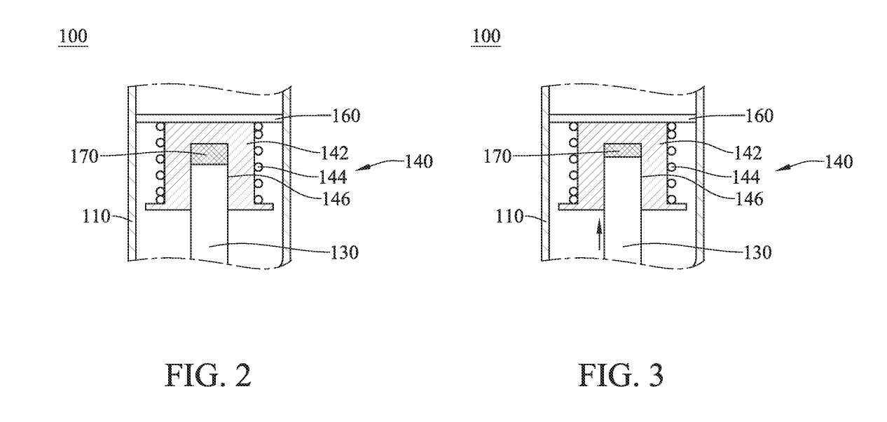

Refer now to FIG. 1 to FIG. 3; where FIG. 1 is a schematic view of an embodiment of the active stylus in accordance with the present invention is shown, FIG. 2 is an enlarged view of a portion of FIG. 1, and FIG. 3 shows another state of FIG. 2.

In this embodiment, the active stylus 100 is applied to the capacitive touch panel (not shown herein) as an input means. The active stylus 100 includes a housing 110, a penetration portion 120, a magnetic structure 130, an induction-coil portion 140, a positioning unit 160, a buffer portion 170, a push-button unit 112 and an oscillation unit 115.

The housing 110 made of a plastics or a metal can be shaped as a hollow square cylinder. The push-button unit 112 is located at an exterior of the housing 110. The housing 110 formed as the hollow square cylinder has an interior accommodation space for nesting thereinside the magnetic structure 130, the induction-coil portion 140, the positioning unit 160, the oscillation unit 115 and a part of the penetration portion 120. In this embodiment, the appearance of the active stylus 100 is not limited to the shape shown in the figure herein. In some other embodiments not shown here, the appearance of the active stylus 100 can be a hollow circular or polygonal cylinder.

The penetration portion 120 located to one end of the housing 110 includes a contact portion 122 protrusive out of the housing 110. The contact portion 122 made of a conductive material is to contact the capacitive touch panel so as thereby to produce a change of the capacitance on the capacitive touch panel.

The induction-coil portion 140 is located inside the housing 110, and the penetration portion 120 located at an end portion of the housing 110 is movably mounted at the induction-coil portion 140. In detail, as shown in FIG. 2, the induction-coil portion 140 further includes a base 142, an induction coil 144 and an accommodation space 146.

The induction coil 144 is wound exteriorly around the base 142. The accommodation space 146 is formed as a central axial blind hole at the base 142 for receiving the magnetic structure 130. In this embodiment, the accommodation space 146 is shaped as a rectangular accommodation room. The buffer portion 170 can be a rectangular cylinder located onto an end wall inside the accommodation space 146. It shall be noted that the buffer portion 170 can be made of a polymer with substantial elasticity. However, in some other embodiments not shown here, the buffer portion can be a round cylinder or a cylinder with a specific cross section, mainly depending on the shape of the accommodation space 146.

The magnetic structure 130 is located inside the penetration portion 120 and connects with the induction-coil portion 140. In detail, the magnetic structure 130 contains thereinside an iron dust core, a ferro magnetic material, an oxidation magnet or the like magnetic ferrite material. The magnetic structure 130 can be a lengthy cylinder, and one end thereof extends into the accommodation space 146 to contact the buffer portion 170. Another end of the magnetic structure 130 is located out of the accommodation space 146. In some other embodiments not shown here, the magnetic structure can be a cylinder with a round cross section or other shape of cross section depending on the formation of the accommodation space 146.

Referring back to FIG. 1, the oscillation unit 115 located inside the housing 110 is electrically coupled with the induction-coil portion 140 (including the induction coil) so as to form an oscillation circuit.

Upon the aforesaid arrangement, when the contact portion 122 of the active stylus 100 is free of contact, the penetration portion 120 and the magnetic structure 130 would be disposed at an initial position. When the contact portion 122 of the active stylus 100 contacts the capacitive touch panel, the contact portion 122 is depressed and then displaces simultaneously the penetration portion 120 and the magnetic structure 130, such that the penetration portion 120 can move in an axial direction and the magnetic structure 130 would be moved away the initial position shown in FIG. 2. Simultaneously, a relative displacement is generated between the magnetic structure 130 and the induction coil 144 of the induction-coil portion 140. Thereby, the induction-coil portion 140 would generate an inductance-varying value, and the oscillation unit 115 would base on the inductance-varying value to generate an oscillation frequency. Also, with the change in forcing at the contact portion 122 of the penetration portion 120, the displacement between the magnetic structure 130 and the induction coil 144 of the induction-coil portion 140 would vary as well. Hence, the capacitive touch panel can calculate the pressure value upon the contact portion 122 of the penetration portion 120.

Obviously, by providing the present invention, the active stylus 100 does not need the MCU of the conventional active stylus or the control unit of the microprocessor to calculate the pressure value at the contact portion 122 of the penetration portion 120 generated by depressing the active stylus 100, such that the overall volume of the active stylus 100 can be smaller, the production cost for the active stylus 100 can be reduced, and the usage convenience of the active stylus 100 can be enhanced.

In detail, the oscillation unit 115 can include a power-control unit (not shown in the figure), at least one voltage-transforming unit (not shown in the figure), a calculation unit (not shown in the figure) and a drive-output unit (not shown in the figure).

The power-control unit can be a battery or a rechargeable battery. The voltage-transforming unit can be a voltage-transforming circuit, a voltage-boosting circuit or a secondary voltage-boosting circuit. The calculation unit can be an oscillation circuit or a Colpitts Circuit. The drive-output unit can be a high-voltage radiating circuit with a power transistor. Under such an arrangement, the oscillation unit 115 can base on the capacitance value (a constant) and the change in inductance to obtain the inductance value and so as further to generate a corresponding oscillation frequency, in which the oscillation frequency is inverse proportional to the multiplication of the inductance value and the capacitance value. Then, according to the oscillation frequency, the drive-output unit performs a transformation to obtain a corresponding frequency signal in a high voltage form, in which the oscillation frequency can be a sinusoidal wave and the frequency signal can be a square wave. Thus, the capacitive touch panel can base on the oscillation frequency or the frequency signal to calculate the pressure value at the contact portion 122 of the depressed penetration portion 120.

Further, the push-button unit 112 is electrically coupled with oscillation unit 115. When the push-button unit 112 is depressed, the oscillation unit 115 would base on the capacitance value (a constant) and the change in inductance to obtain an inductance value and further to generate a corresponding oscillation frequency with respect to this specific push-button action. Thus, the capacitive touch panel can judge function of each signal generated by the push-button unit 112.

In addition, when the contact forcing at the contact portion 122 of the penetration portion 120 gradually goes away, the buffer portion 170 would gradually resume a free-of-forcing state. During this resuming period, the buffer portion 170 utilizes its own resilience to push the magnetic structure 130 back to the initial position shown in FIG. 2 from the depressed position shown in FIG. 3. Thereby, the penetration portion 120 can resume back its initial position.

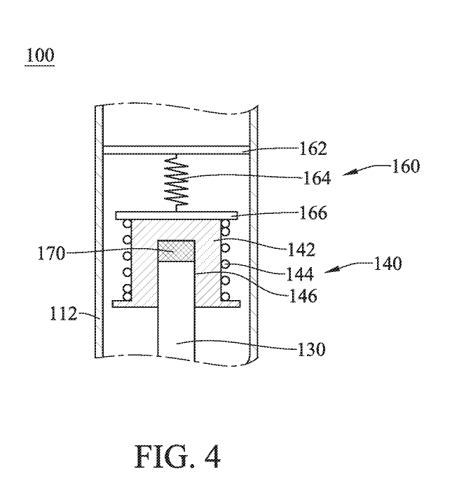

Further, the positioning unit 160 located inside the housing 110 is connected with the induction-coil portion 140. Referring now to FIG. 4, a schematic detail view of the positioning unit of FIG. 1 is shown. The positioning unit 160 includes a stop member 162, a spring member 164 and a connection member 166.

The stop member 162 is fixed in the housing 110. The connection member 166 is located on the base 142. The spring member 164 is to bridge the stop member 162 and the connection member 166. The spring member 164 can be a spring, an elastic strip or element, or a member made of an elastomer such as a rubber.

Under such an arrangement, when the contact portion 122 of the penetration portion 120 contacts the touch screen of the capacitive touch panel, the penetration portion 120, the magnetic structure 130, the induction-coil portion 140 and the connection member 166 move simultaneously to push and squeeze the spring member 164 so as to deform the spring member 164. When the forcing upon the contact portion 122 of the penetration portion 120 gradually goes away, the spring member 164 would resume its original state gradually. With the resilience of the spring member 164, the connection member 166 and the induction-coil portion 140 is pushed to move and further to drive the magnetic structure 130 back to the initial position as shown in FIG. 2, such that the penetration portion 120 can also be back to its initial position.

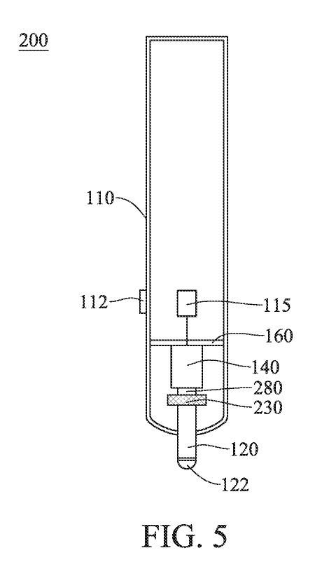

Referring now to FIG. 5, a schematic view of another embodiment of the active stylus in accordance with the present invention is shown. The active stylus 200 of FIG. 5 is largely resembled to the active stylus 100 of FIG. 1, and thus descriptions of the same elements would be omitted herein.

In this embodiment, the arrangement of the magnetic structure 230 is different to that of the magnetic structure 130 of FIG. 1. The active stylus 200 of this embodiment further includes an elastic unit 280 to connect with the induction-coil portion 140.

In this embodiment, the elastic unit 280 is made of an elastomer such as a rubber.

The magnetic structure 230 is located between the elastic unit 280 and the penetration portion 120 and at a position right under the elastic unit 280. Upon such an arrangement, when the contact portion 122 of the penetration portion 120 contacts the capacitive touch panel, this contact action would move the contact portion 122, the penetration portion 120 and the magnetic structure 230 synchronously so as to further push the elastic unit 280 to generate an elastic deformation. Simultaneously, a relative displacement would be formed between the magnetic structure 230 and the induction-coil portion 140, such that a change of inductance in the induction-coil portion 140 would be produced.

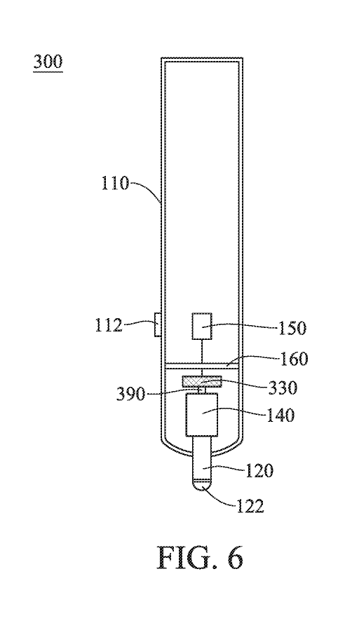

Referring now to FIG. 6, a schematic view of a further embodiment of the active stylus in accordance with the present invention is shown. The active stylus 300 of FIG. 6 is largely resembled to the active stylus 200 of FIG. 5, and thus descriptions of the same elements would be omitted herein.

In this embodiment, the arrangement of the magnetic structure 330 is different to that of the magnetic structure 230 of FIG. 2. The active stylus 300 of this embodiment further includes an elastic unit 390 made of an elastomer such as a rubber.

In this embodiment, the positioning unit 160, the magnetic structure 330, the elastic unit 390 and the induction-coil portion 140 are connected orderly in series.

Upon such an arrangement, when the contact portion 122 of the penetration portion 120 contacts the capacitive touch panel, this contact action would move the contact portion 122, the penetration portion 120, the induction-coil portion 140, the elastic unit 390 and the magnetic structure 330 synchronously, and thus the elastic unit 390 located between the induction-coil portion 140 and the magnetic structure 330 would be squeezed to generate an elastic deformation. Simultaneously, a relative displacement would be formed between the magnetic structure 330 and the induction-coil portion 140, such that a change of inductance in the induction-coil portion 140 would be produced. In addition, when the elastic unit 390 is squeezed, the magnetic structure 330 can also serve as a stop structure.

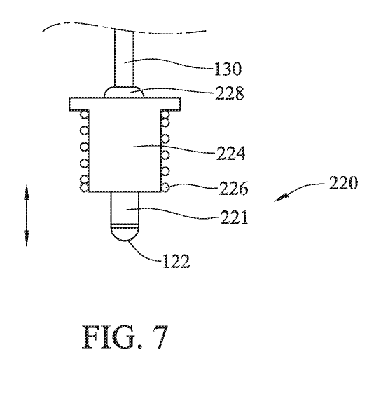

Referring now to FIG. 7, a schematic detail view of the penetration portion of FIG. 1 is shown.

As shown, the penetration portion 220 further includes a rod element 221, a stud element 224, a spring element 226, and a contact element 228.

The spring element 226 is to sleeve the stud element 224. On end of the stud element 224 is connected to an upper end of the rod element 221, while the lower end of the rod element 221 is to construct the contact portion 122. Also, another end of the stud element 224 is connected to a bottom of the contact element 228. The magnetic structure 130 is connected to a top of the contact element 228. Under such an arrangement, the rod element 221 can move synchronously with the stud element 224, and to further push the magnetic structure 130 to displace via the contact element 228. However, in another embodiment not shown herein, the rod element 221, the stud element 224 and the contact element 228 can be integrated as a unique piece. Also, the embodiment of the penetration portion 220 is not strictly limited to the aforesaid configuration.

In summary, by providing the active stylus of the present invention, when the contact portion of the penetration portion contacts the capacitive touch panel (especially on the touch screen), such a contact would move the contact portion, the penetration portion and the magnetic structure synchronously so as to generate a relative displacement between the magnetic structure and the induction-coil portion, and further to have the induction-coil portion to produce a change of inductance. The oscillation unit bases on the change of inductance to generate a corresponding oscillation frequency. Thus, the capacitive touch panel can then calculate the pressure value at the contact portion of the depressed penetration portion. Hence, the active stylus of the present invention does not need the control unit, such as the MCU or the microprocessor of the conventional active stylus, to calculate the pressure value of the depressed active stylus. Thus, the overall volume of the active stylus can be smaller, the production cost for the active stylus can be reduced, and the usage convenience of the active stylus can be enhanced.

Furthermore, when the contact forcing upon the contact portion of the penetration portion gradually dies away, the buffer portion would gradually resume its original or initial state. The buffer portion provides its own resilience to push the magnetic structure back to its initial position, and thereby the penetration portion can also resume its initial position.

In addition, when the push-button unit is depressed, the oscillation unit would base on the capacitance value (a constant) and the change of inductance to obtain the corresponding inductance value, so that the oscillation frequency corresponding to the push-button action can be related, and thus the capacitive touch panel can tell specific button function corresponding to the signal of push-button unit.

While the present invention has been particularly shown and described with reference to a preferred embodiment, it will be understood by those skilled in the art that various changes in form and detail may be without departing from the spirit and scope of the present invention.

What is claimed is:

1. An active stylus, applied to a capacitive touch panel as an input means, comprising:
a housing;
an induction-coil portion, located inside the housing;
a penetration portion, located at an end portion of the housing and movably mounted at the induction-coil portion, further including a contact portion protrusive out of the housing to contact the capacitive touch panel; and
a magnetic structure, located between the induction-coil portion and the penetration portion;
wherein, when the contact portion contacts the capacitive touch panel, the contact portion moves the penetration portion and the magnetic structure synchronously so as to generate a relative displacement between the magnetic structure and the induction-coil portion and further to have the induction-coil portion to produce a change of inductance.

2. The active stylus of claim 1, further including:
an oscillation unit, located inside the housing, electrically coupled with the induction-coil portion, the oscillation unit basing on the change of inductance to generate an oscillation frequency.

3. The active stylus of claim 2, further including:
a push-button unit, located exteriorly to the housing, electrically coupled with the oscillation unit.

4. The active stylus of claim 1, wherein the induction-coil portion includes a base, an induction coil and an accommodation space, the accommodation space being formed as a central axial blind hole at the base for receiving the magnetic structure in a manner of having a part of the magnetic structure located in the accommodation space, the induction coil being wound exteriorly around the base.

5. The active stylus of claim 4, further including:
a buffer portion, located onto an end wall inside the accommodation space, the magnetic structure contacting the buffer portion.

6. The active stylus of claim 4, further including:
a positioning unit, located inside the housing, connecting the induction-coil portion, further including a stop member, a spring member and a connection member, the connection member being located on the base, the spring member bridging the stop member and the connection member.

7. The active stylus of claim 1, wherein the penetration portion further includes a rod element, a stud element, a spring element and a contact element, the spring element sleeving the stud element, one end of the stud element connecting an upper end of the rod element, a lower end of the rod element being to construct the contact portion, another end of the stud element connecting a bottom of the contact element, the magnetic structure connecting a top of the contact element.

8. An active stylus, applied to a capacitive touch panel as an input means, comprising:
a housing;
an induction-coil portion, located inside the housing;
a penetration portion, located at an end portion of the housing 110 and movably mounted at the induction-coil portion, further including a contact portion protrusive out of the housing to contact the capacitive touch panel;
an elastic unit, connecting the induction-coil portion; and
a magnetic structure, connecting the elastic unit;
wherein, when the contact portion contacts the capacitive touch panel, the contact portion moves the penetration portion and the magnetic structure synchronously so as to generate a relative displacement between the magnetic structure and the induction-coil portion and further to have the induction-coil portion to produce a change of inductance.

9. The active stylus of claim 8, further including:
an oscillation unit, located inside the housing, electrically coupled with the induction-coil portion, the oscillation unit basing on the change of inductance to generate an oscillation frequency.

10. The active stylus of claim 9, further including:
a push-button unit, located exteriorly to the housing, electrically coupled with the oscillation unit.

11. The active stylus of claim 8, wherein the induction-coil portion includes a base, an induction coil and an accommodation space, the accommodation space being formed as a central axial blind hole at the base for receiving the magnetic structure in a manner of having a part of the magnetic structure located in the accommodation space, the induction coil being wound exteriorly around the base.

12. The active stylus of claim 11, further including:
a buffer portion, located onto an end wall inside the accommodation space, the magnetic structure contacting the buffer portion.

13. The active stylus of claim 8, wherein the magnetic structure is located between the elastic unit and the penetration portion.

14. The active stylus of claim 11, further including:
a positioning unit, located inside the housing, connecting the induction-coil portion, further including a stop member, a spring member and a connection member, the connection member being located on the base, the spring member bridging the stop member and the connection member.

15. The active stylus of claim 14, wherein the magnetic structure is located between the elastic unit and the positioning unit.
